(19) United States
(12) Patent Application Publication
(10) Pub. No.: US 2013/0067866 A1
(43) Pub. Date: Mar. 21, 2013

(54) Resealable packaging device and method for packaging collectible items

(71) Applicant: Patrick Zacard, Blainville (CA)

(72) Inventor: Patrick Zacard, Blainville (CA)

(21) Appl. No.: 13/460,227

(22) Filed: Apr. 30, 2012

(30) Foreign Application Priority Data
Sep. 19, 2011 (GB) GB1116168.4

(51) Int. Cl. B65B 11/00; B31B 1/62

(52) U.S. Cl. 53/461; 493/264

(57) ABSTRACT

A resealable packaging device comprises a frame having a combination of multiple layers made of opaque material, each opaque layer comprising one ore more apertures for insertion of a display container. The display container comprises a removable transparent cover or cap surrounded by rigid opaque material allowing one or more items to be sealed within the display container. A method for packaging at least one object is also disclosed.

### CROSS-REFERENCE TO RELATED APPLICATIONS

The present patent application claims the benefits of priority of United Kingdom Patent Application no. GB1116168.4, entitled “Accessible window display device for at least one object” and filed at the United Kingdom Intellectual Property Office on Sep. 19, 2011.

### FIELD OF THE INVENTION

The present invention generally relates to packaging of article allowing the display of such article and particularly to devices having at least one window and to a method for packaging collectible items.

### BACKGROUND OF THE INVENTION

Packaging for collectible article such as coins, cards, hairs, medals, or small quantities of precious ore or soil have been used and seen on the market for many years, and even decades. Over the years, many methods have been developed to display a collectible in a package. As examples, the collectible may be snapped in or on a paper board, sandwiched between two layers of flexible material or sealed in a plastic container or bubble.

U.S. patent application published under no. U.S. 2010/0084289, filed Aug. 14, 2009 and entitled “Coin storage and display device”, discloses a coin storage and display device allowing the display of article using a plastic sheet comprising one or more retaining structure. This invention is limited to display one or more articles having planar sides, such as coins or medallions. Furthermore, the snapping mechanism prevents the sealing of the article within a package.

U.S. Pat. No. 7,100,761 (referred as “'761”), filed on Sep. 5, 2006 and entitled “Rotatable coin display”, discloses a display for collectible item which may be rotated and where the display comprises a bubble made of semi-rigid transparent material. The '761 patent allows the item to be permanently sealed within the bubble while allowing rotation of the said bubble. However, the collectible item being permanently sealed implies that the item must be inserted within the display at the time of manufacturing the packaging. Also, the rotatable display limits the shape of the display container to a generally circular shape, thus limiting the collectible items to coins, rounded medallions and other items fitting in a generally circular shape. Furthermore, a user is not able to open and access the collectible item contained in the display bubble.

There is a need for a display device for preserving one or more collectible items which mitigates at least some shortcomings of prior art display devices.

### SUMMARY OF THE INVENTION

One of the aspects of the present invention is to provide a resealable package for one or more collectible items, wherein the package comprises a typically transparent capsule or container having a removable top part allowing the content to be accessed or removed or to be replaced by new content.

A further apsect of the present invention is to provide a package for one or more collectible items having any peripheral shape such as circular, rectangular, pentagonal or any other custom shape.

Another aspect of the present invention is to provide a method for packaging collectible items, wherein such method may allow a retailer, manufacturer or customer of collectible items to place one or more item in the package while being able to seal the package.

In order to do realize the foregoing and other aspects, the present invention generally comprises a capsule comprising a base portion and a cover configured to display an object, wherein the base portion and the cover are configured to be sealingly mounted together and wherein the cover is made of transparent material, at least two padding layers comprising at least one aperture, at least one covering film layer, at least one adhesive layer and at least one cover layer. In this embodiment, the at least two padding layers, the at least one covering film layer, the at least one adhesive layer and the at least one cover layer are affixed together.

In another embodiment, the packaging device for displaying at least one object comprises a capsule comprising a base portion and a cover configured to display an object, wherein the base portion and the cover are configured to be sealingly yet removably mounted together and wherein the cover is made of transparent material. The packaging further comprises two padding layers comprising at least one aperture wherein the packaging device comprises two superposed padding layers, a bottom padding layer and a top padding layer, the aperture of the bottom padding layer is configured to allow the peripheral delimitation and the surface of the flange of the capsule to tightly fit into the aperture of the bottom padding layer, the surface of the aperture of the top padding layer is generally inferior to the aperture of the bottom layer.

Furthermore, the packaging device comprises at least one covering film layer made of a polypropylene film, at least one heat activated adhesive layer and at least one cover layer made with a material allowing to be printed on. The at least two padding layers, the at least one covering film layer, the at least one adhesive layer and the at least one cover layer are affixed together.

In a further embodiment, a method for packaging at least one object using a packaging device comprising a capsule comprising a base portion and a cover configured to display an object, at least two padding layers comprising at least one aperture, at least one covering film layer, at least one adhesive layer and at least one cover layer wherein the at least two padding layers, the at least one covering film layer, the at least one adhesive layer and the at least one cover layer are affixed together. The method for packaging comprises the steps for bonding the at least two padding layers together using a sealing adhesive, in such a way that the apertures of each padding layer are centrally aligned, for adding at least one covering film layer by applying to the at least two padding layers an adhesive and at least one covering film, for applying at least one adhesive layer on the at least one covering film layer, for centrally aligning the at least one aperture of the at least one cover layer with the at least one aperture of the bonded padding layers, for bonding the at least one cover layer to the package, for inserting the at least one object in the capsule and for securing the cover through the aperture of the at least one cover layer where the capsule is installed.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is an exploded view of a display device in accordance with the present invention.

FIGS. 2a and 2b are a cutaway side view and a cutaway detail, respectively, of a display device in accordance with the present invention.

FIG. 3 is an isometric view of a display device in accordance with the present invention.

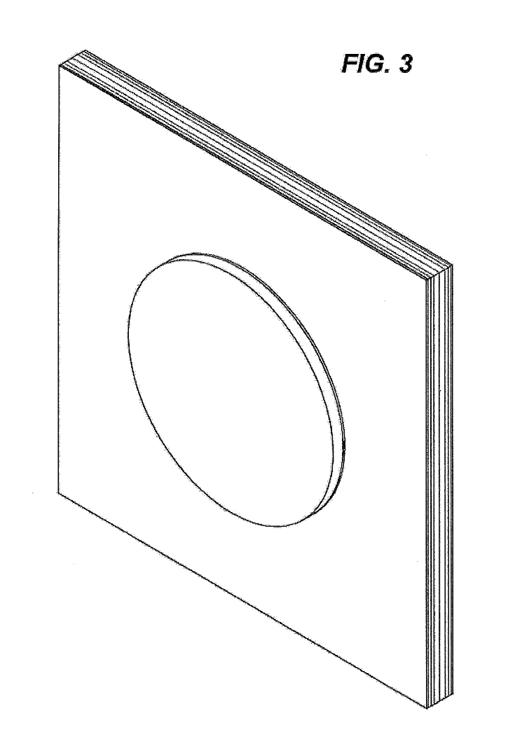

FIGS. 4a and 4b are front and side views, respectively, of a display device in accordance with the present invention.

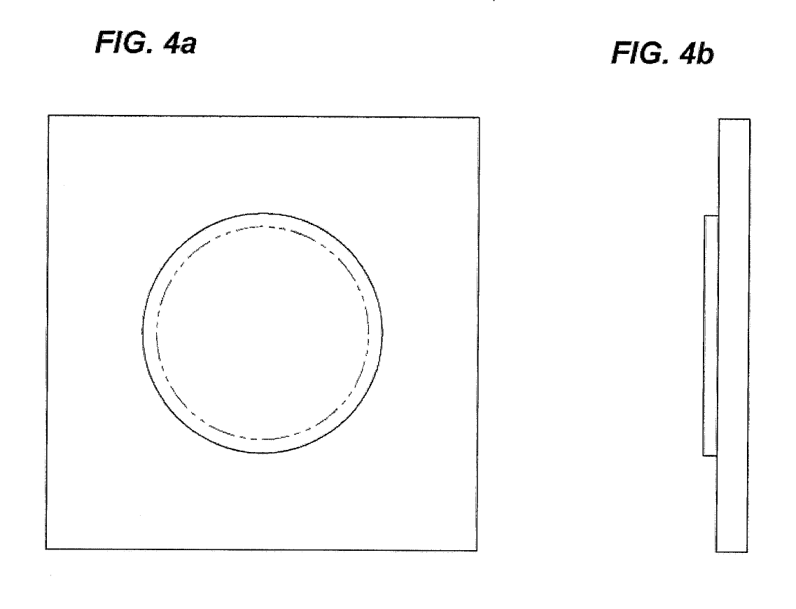

### DETAILED DESCRIPTION OF THE PREFERRED EMBODIMENT

A novel resealable packaging device and method for packaging collectible items will be described hereinafter. Although the invention is described in terms of specific illustrative embodiment(s), it is to be understood that the embodiment(s) described herein are by way of example only and that the scope of the invention is not intended to be limited thereby.

A resealable packaging device in accordance with the present invention generally comprises a frame having a combination of multiple layers made of opaque material, each opaque layer comprising one ore more apertures for insertion of a display container. The display container comprises a removable transparent cover or cap surrounded by rigid opaque material allowing one or more collectible items to be sealed within the display container.

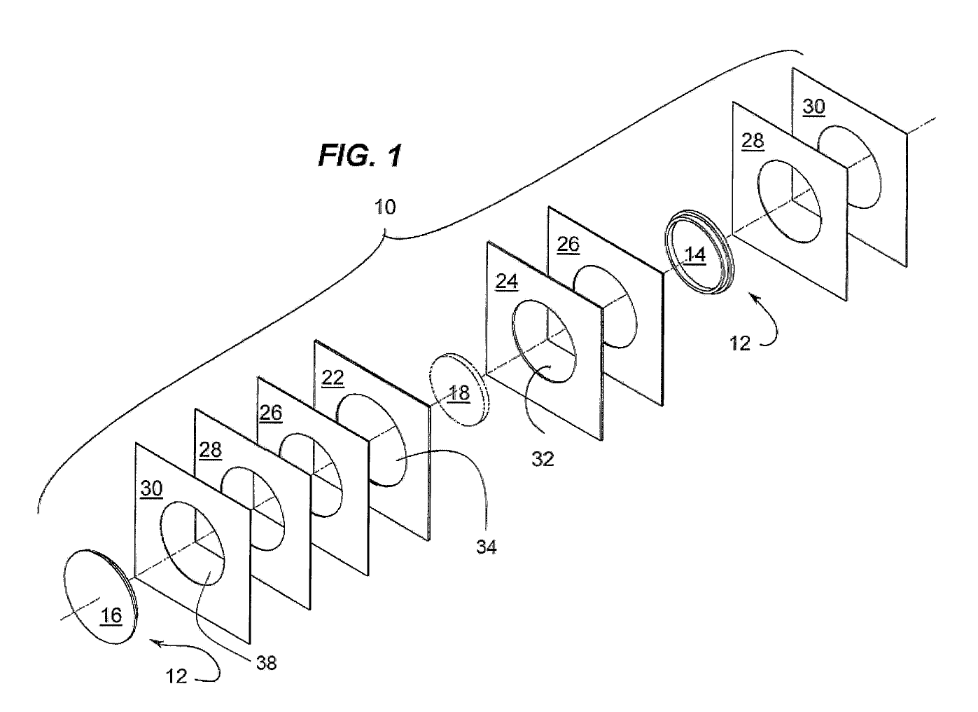

Referring to FIG. 1, the resealable packaging device comprises a capsule 12 having a base portion 14 and a cover 16 to display a collectible item 18, at least two padding layers 22 and 24, at least one covering film layers 26, at least one adhesive layer 28 and at least one cover layer 30.

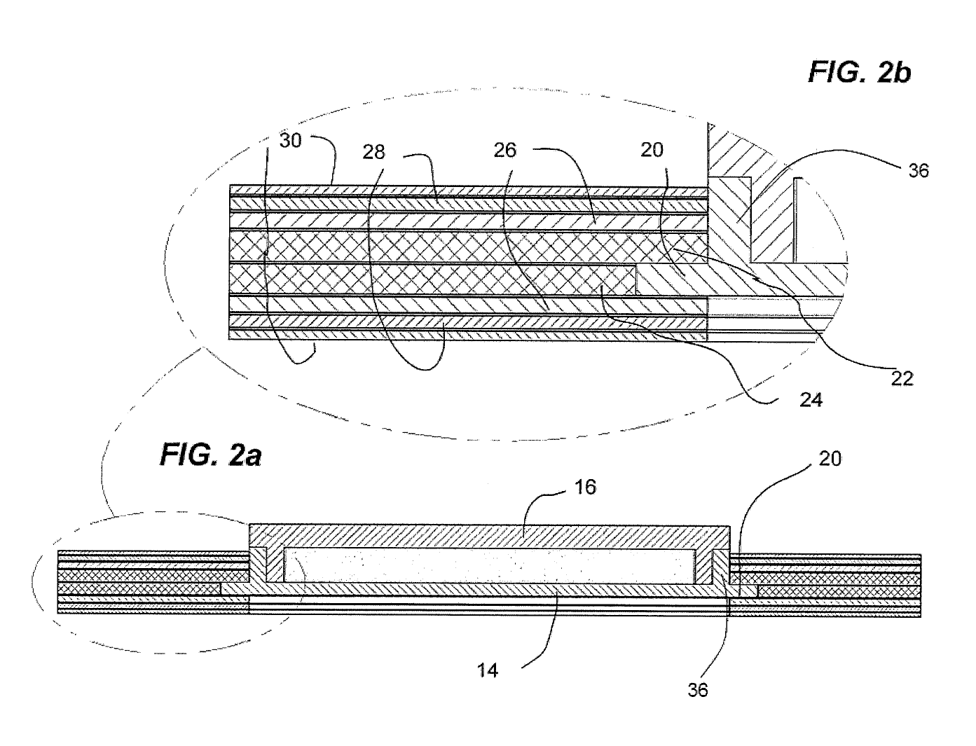

In the embodiment shown in FIGS. 1, 2a and 2b, the capsule 12 is made of generally transparent semi-rigid material such as, but not limited to, moulded high density styrene or acrylic, preferably crystal clear. The capsule 12 may be shaped as any given shape having any dimension. The support material is taken for the group of material including but not limited to polyester, polypropylene, cardboard or padding board.

The capsule 12 comprises two interlocking elements, a base portion 14 and a cover 16. The base portion 14 comprise a flange 20 and at least one side wall 36 keeping the at least one item 18 secured. The base portion 14 is moulded for the flange 20 to extend from the outer perimeter of the capsule 12. The cover 16 is shaped and dimensioned to be snapped or attached to the base portion 14 in order to seal the capsule 12. Preferably, the cover 16 comprises a groove portion made of two rims configured to be sealingly mounted on the side wall 36 of the base portion 14. Those skilled in the art shall notice that any engagement method allowing the cover 16 to seal the base portion 14 shall be used to mount the base portion 14 to the cover 16. In a preferred embodiment, the cover 16 may be removed any number of times from the base portion 14.

Although in the embodiment shown, the base portion 14 and the cover 16 are both transparent, in another embodiment (not shown) only one of the two needs to be transparent.

Still referring to FIGS. 1, 2a and 2b, the padding layers, the bottom layer 22 and top layer 24, are generally made of cardboard or any other semi-rigid material such polyester, polypropylene, any other semi-rigid plastic or polymer or flexible metal such as aluminum. Both padding layers 22 and 24 comprise at least one aperture 32 allowing the base portion 14 of the capsule 12 to be inserted. The aperture 34 of the bottom layer 22 is dimensioned and shaped to allow the peripheral delimitation and surface of the flange 20 of the capsule 12 to tightly fit into the aperture 34. The surface of the aperture 32 of the top layer 24 is generally inferior to the aperture 34 of the bottom layer 22 and is dimensioned and shaped to allow the peripheral delimitation and surface of the side wall 36 of the capsule 12 to tightly fit into the top layer 24 aperture 32. The bottom padding layer 22 thickness shall be same as the flange 20 thickness in order to provide a flat bottom surface of the packaging, thus creating a aesthetically looking package. The thickness of the top padding layer 24 shall be adapted to provide a flat top surface. To determine the thickness of the at least one top padding layer 24, one skilled in the art shall consider the thickness of the at least one cover layer 30, the thickness of the film layer 26, the height of the side wall 36, the thickness of the at least one adhesive layer 28 and the thickness of any other additional layer that may be required.

The at least two padding layers 22 and 24 are bonded or affixed together, using hot melt adhesives or any other sealing adhesive, in such a way that the apertures 32 and 34 are centrally aligned.

In another embodiment, the padding layers 22 and 24 are embodied as a single sheet of semi-rigid material being folded, thus creating a multilayer sheet wherein each layer is bonded to the other layers using adhesives as described above.

The at least covering film layer 26 is generally made of a polypropylene film (OPP) and is applied to the at least two padding layers 22 and 24 with an adhesive, preferably cold application adhesive. The top surface of the film layer 26 is coated with at least one adhesive layer 28.

The adhesive layer 28 is generally embodied as a heat activated adhesive. Thus, the film layer 26 creates a barrier to the adhesive layer 28, thus preventing the adhesive from being absorbed by the generally porous semi-rigid material of the padding layers 22 and 24. Such film layer 26 creating a barrier is required to maintain the bonding integrity of the packaging.

The at least one cover layer 30 allows the package 10 to be aesthetically attractive or to be informative as to print information on the at least one packaged item. The at least one cover layer 30 comprises at least one aperture 38 dimensioned and shaped to allow the cover 16 of the capsule 12 to be fitted. The at least one cover layer 30 is preferably made with cardboard but may be made with any other material allowing to be printed on. The at least one cover layer 30 is bonded or adhered to the padding board by applying heat and pressure in order in order to activate the heat-adhesive of the at least one film layer 26.

A method for packaging collectible items in accordance with the present invention comprises a step for bonding the at least two padding layers 22 and 24 together using a sealing adhesive, in such a way that the apertures 32 and 34 are centrally aligned.

The method further comprises a step of adding at least one covering film layer 26 by applying to the at least two padding layers 22 and 24 an adhesive and at least one covering film. Another step of the method is to push the base portion 14 of the capsule 12 through the bottom and top padding layers 22 and 24. As a result, the flange 20 of the base 14 will be held against the flange created by the smaller aperture 34 of the top padding layer 22 being centrally bonded to the aperture 34 of the bottom padding layer 24. This step allows the bottom portion 14 of the capsule 12 to be held in place.

The method comprises a further step for applying at least one adhesive layer 28 over the at least one film layer 26. Typically, a heat activated adhesive shall be applied. Then, the at least one cover layer is installed over the package by centrally aligning the at least one aperture 38 of the cover layer 30 with the at least one aperture 32 and 34 of the bonded padding layers 22 and 24. To bond the at least one cover layer 30 to the package, heat and pressure are applied on the at least one cover layer 30 in order in order to activate the heat-adhesive of the at least one film layer 26 and to heat seal the package 10.

Once the at least one cover layer 30 is heat sealed with the package, the at least one collectible item 18 may be inserted in the base portion 14 of the capsule 12 and the cover 16 may be snapped or secured in place through the at least one aperture 38 of the cover layer 30.

The method may comprise a step to die-cut or cut to any shape and size, prior to assembly, the at least one cover layer 30 and the at least two padding layers 22 and 24. Furthermore, the capsule may be moulded prior to the assembling of the resealable packaging device.

A method to use a resealable packaging device in accordance with the present invention comprises the steps of inserting an item 18 into the bottom portion 14 of the capsule 12 and to seal the capsule by snapping or securing the cover 16 through the at least one cover layer 30 aperture 38 where the capsule 12 is installed. The method to use a resealable packaging device may comprise the steps of removing the cover 16 of the sealed capsule 12 and for retrieving or accessing the item 18.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1. A packaging device for displaying at least one object, the packaging device comprising:
a) a capsule comprising a base portion and a cover configured to display an object, wherein the base portion and the cover are configured to be sealingly mounted together and wherein the cover is made of transparent material;
b) at least two padding layers each comprising at least one aperture for receiving the capsule;
c) at least one covering film layer disposed over at least one of the at least two padding layers;
d) at least one adhesive layer disposed over any of the at least two padding layers or the at least one padding layer;
e) at least one cover layer disposed over the at least one adhesive layer;
wherein the at least two padding layers, the at least one covering film layer, the at least one adhesive layer and the at least one cover layer are affixed together.

2. A packaging device for displaying at least one object according to claim 1, wherein the at least two padding layers, the at least one covering film layer, the at least one adhesive layer and the at least one cover layer are bonded together in such a way that the at least one aperture of each layer having an aperture are centrally aligned.

3. A packaging device for displaying at least one object according to claim 2, wherein the base portion and the cover of the capsule are shaped and dimensioned to be sealingly yet removably mounted together.

4. A packaging device for displaying at least one object according to claim 3, wherein the base portion of the capsule comprises a flange and at least one side wall keeping the at least one object secured.

5. A packaging device for displaying at least one object according to claim 4, wherein the adhesive layer comprises a heat activated adhesive.

6. A packaging device for displaying at least one object according to claim 4, wherein the at least two padding layers are bonded together using sealing adhesive.

7. A packaging device for displaying at least one object according to claim 5, wherein the at least two padding layers are bonded together using sealing adhesive.

8. A packaging device for displaying at least one object according to claim 4, wherein the base portion is made of transparent material.

9. A packaging device for displaying at least one object according to claim 6, wherein the at least two padding layers are made of semi-rigid material.

10. A packaging device for displaying at least one object according to claim 9, wherein the at least covering film layer is made of a polypropylene film, wherein:
a) the covering film layer is bonded to the at least two padding layers using an adhesive;
b) the top surface of the covering film layer is coated with the least one adhesive layer.

11. A packaging device for displaying at least one object according to claim 10, wherein the adhesive to applied to the covering film is cold application adhesive.

12. A packaging device for displaying at least one object according to claim 4, wherein the at least one adhesive layer comprises heat activated adhesive.

13. A packaging device for displaying at least one object according to claim 12, wherein the at least one cover layer is made with a material allowing to be printed.

14. A packaging device for displaying at least one object, the packaging device comprising:
a) a capsule comprising a base portion and a cover configured to display an object, wherein the base portion and the cover are configured to be sealingly yet removably mounted together and wherein the cover is made of transparent material;
b) two padding layers each comprising at least one aperture wherein:
i) the packaging device comprises two superposed padding layers, a bottom padding layer and a top padding layer;
ii) the aperture of the bottom padding layer is configured to allow the peripheral delimitation and the surface of the flange of the capsule to tightly fit into the aperture of the bottom padding layer;
c) the aperture of the top padding layer being smaller than is generally inferior to the aperture of the bottom layer;
d) at least one heat activated adhesive layer disposed over any of the at least two padding layers or the at least one padding layer;
e) at least one cover layer made with a material allowing to be printed on and disposed overt the at least one adhesive layer;
wherein the at least two padding layers, the at least one covering film layer, the at least one adhesive layer and the at least one cover layer are affixed together.

15. A packaging device for displaying at least one object according to claim 14, wherein the thickness of the top padding layer and of the bottom padding layer are adapted to the thickness of the flange in order to provide a flat bottom surface of the packaging.

16. A method for packaging at least one object using a packaging device comprising a capsule comprising a base portion and a cover configured to display an object, at least two padding layers comprising at least one aperture, at least one covering film layer, at least one adhesive layer and at least one cover layer wherein the at least two padding layers, the at least one covering film layer, the at least one adhesive layer and the at least one cover layer are affixed together and wherein the method comprises the steps for:
a) bonding the at least two padding layers together using a sealing adhesive, in such a way that the apertures of each padding layer are centrally aligned;
b) adding at least one covering film layer by applying to the at least two padding layers an adhesive and at least one covering film;
c) applying at least one adhesive layer on the at least one covering film layer;
d) centrally aligning the at least one aperture of the at least one cover layer with the at least one aperture of the bonded padding layers;
e) bonding the at least one cover layer to the package;
f) inserting the at least one object in the capsule;
g) securing the cover through the aperture of the at least one cover layer where the capsule is installed

17. A method for packaging at least one object according to claim 16, wherein the method further comprises the step to remove the cover of the sealed capsule to gain access the at least one object.

18. A method for packaging at least one object according to claim 16, wherein the bonding process of the step e) comprises the application of heat and pressure on the at least one cover layer in order in order to activate a heat-adhesive of the at least one film layer and to heat seal the packaging device.

19. A method for packaging at least one object according to claim 18, wherein the method further comprises a step to cut the at least one cover and the at least two padding layers to any shape and size, prior to assembly.
